(19) United States
(12) Patent Application Publication
(10) Pub. No.: US 2015/0058091 A1
(43) Pub. Date: Feb. 26, 2015

(54) METHOD AND SYSTEM FOR LNAPL REMOVAL BENEFIT ANALYSIS

(71) Applicant: Earth Consulting Group, Inc., Marietta, GA (US)

(72) Inventors: Timothy O. Goist, Marietta, GA (US); Joe A. Ricker, Marietta, GA (US)

(73) Assignee: EARTH CONSULTING GROUP, INC., Marietta, GA (US)

(21) Appl. No.: 14/459,553

(22) Filed: Aug. 14, 2014

Related U.S. Application Data
(60) Provisional application No. 61/865,698, filed on Aug. 14, 2013.

(51) Int. Cl. G06Q 10/06

(52) U.S. Cl. CPC G06Q 10/0637
USPC 705/7.36

(57) ABSTRACT

A new environmental application, sometimes referred to as the LNAPL Removal Benefit Analysis is disclosed for evaluating the relative benefit of removing LNAPL from a site that has LNAPL and a related dissolved phase groundwater plume.

### CROSS-REFERENCE TO RELATED APPLICATION

This Application claims the benefit of U.S. Provisional Application 61/865,698 filed on Aug. 14, 2013, incorporated by reference for all legitimate purposes.

### BACKGROUND

1. Field of the Invention

Embodiments disclosed herein relate to methods and systems for evaluating the benefit of removing LNAPL from a site with LNAPL and a related dissolved phase groundwater plume.

2. Background Art

Evaluating the relative stability of a dissolved groundwater contaminant plume is generating increasing attention as many state regulatory agencies, EPA and private stakeholders are realizing the applicability of plume stability as part of the environmental evaluation and/or remedial planning process of a site. Specifically, a plume stability evaluation will allow the stakeholder to assess whether a contaminant plume is stable, decreasing or increasing in size. Assessing the stability of a plume will allow the stakeholder to evaluate whether additional remedial action is necessary or whether risk-based closure of a site may be applicable or whether natural attenuation is occurring at a site. There are many other ancillary applications of plume stability evaluations as related to groundwater contamination.

One of the seminal works in plume stability evaluation is the Ricker Plume Stability Method™ (Ricker, 2008). The Ricker Method® of evaluating plume stability provided by EarthCon Consultants, Inc. involves the evaluation of a groundwater plume in terms of areal extent, average concentration, mass indicator, and location of the plume center of mass. The Ricker Method® plume stability analysis is especially useful and practical as it is not a “model” but rather an empirical evaluation of specific data. The drawbacks of a model include the fact that output is heavily dependent on the proper use and selection of a potentially wide range of variable input data. Additionally, models by nature can be manipulated and interpreted differently by various modelers. Therefore, replication of modeled data becomes more complicated as the amount and variability of input data increases.

Using the outputs of the Ricker Method® plume stability analysis as a platform, the Applicants developed a proprietary remediation system site evaluation tool called the Remediation System Benefit Analysis or RSBA®. The RSBA® tool is applied to sites having active groundwater remediation systems (e.g. pump and treat) and where plume stability has been evaluated using the Ricker Method® plume stability analysis. The RSBA® tool provides an evaluation of the relative impact an active groundwater remediation system (e.g. pump and treat) is having on plume stability at a site. In essence, the RSBA® tool analyzes the amount of contaminant mass that is being removed by a remediation system and the relative impact such removal is having on the stability of the plume. Additionally, RSBA® provides an evaluation of the costs to maintain such a system in context of efficiency/inefficiency (i.e. expensive or inexpensive). It should be noted that the RSBA® tool was designed for evaluating remediation systems removing dissolved-phase contaminants from groundwater and not for evaluating the removal of light non-aqueous phase liquid (LNAPL) contaminants from groundwater.

Accordingly, there exists a continuing need for methods and systems that allow a stakeholder to evaluate the benefit of removing LNAPL from a groundwater remediation site.

### SUMMARY

In general, in one aspect, embodiments of the invention, a new environmental application, referred to as LNAPL Removal Benefit Analysis is disclosed for evaluating the relative benefit of removing LNAPL from a site that has LNAPL and a related dissolved phase groundwater plume. In one or more embodiments the novel LNAPL Removal Benefit Analysis involves the evaluation of up to eight metrics listed below and of which Nos. 7 and 8 are optional. The metrics to be evaluated include: 1) evaluation of dissolved plume stability using the Ricker Method® plume stability analysis, 2) evaluation of potential asymptotic LNAPL recovery curve, 3) evaluation of relative cost trend, 4) evaluation of cost-benefit indicator of $ spent per unit volume of LNAPL removed, 5) evaluation of relative sustainability, 6) evaluation of LNAPL transmissivity, 7) evaluation of a comparison of the relative LNAPL center of mass movement compared to the dissolved plume center of mass movement, and 8) evaluation of the estimate of LNAPL mass loss through the measurement of CO2 off-gassing when applicable (i.e., natural source zone depletion, or NSZD). The outcome of the LNAPL Removal Benefit Analysis will guide the stakeholder in making the decision as to whether it makes sense to remove LNAPL from a site that has LNAPL and a related dissolved phase groundwater plume.

In general, in one or more embodiments, the fifth metric (“5)” above), namely, the relative sustainability, may be determined by use of one or more available tools including the “SiteWise™ Tool for Calculating Environmental Footprint of Remediation Alternatives” and/or the “Sustainable Remediation Tool (SRT) developed by the Air Force Center for Engineering and the Environment (AFCEE)”.

Other aspects of the invention will be apparent from the following description and the appended claims.

### BRIEF DESCRIPTION OF DRAWINGS

FIG. 1 is an example graphical representation of the cumulative amount of LNAPL recovered (y-axis) plotted as a curve over a period of time (x-axis) that is determined to be “non-asymptotic”.

FIG. 2 is an example graphical representation of the cumulative amount of LNAPL recovered (y-axis) plotted as a curve over a period of time (x-axis) that is determined to be “approaching asymptotic”.

FIG. 3 is an example graphical representation of the cumulative amount of LNAPL recovered (y-axis) plotted as a curve over a period of time (x-axis) that is determined to be “asymptotic”.

FIG. 4 is an example graphical representation of a plotting of the linear regression trend line of money ($) spent per volume unit (e.g. gallons, liters, etc.) of LNAPL removed over time representing an increasing cost trend.

FIG. 5 is an example graphical representation of a plotting of the linear regression trend line of money ($) spent per volume unit (e.g. gallons, liters, etc.) of LNAPL removed over time representing a decreasing cost trend.

FIG. 6 is an example graphical representation of a plotting of the linear regression trend line of money ($) spent per volume unit (e.g. gallons, liters, etc.) of LNAPL removed over time representing a stagnant (or static) cost trend.

FIG. 7 is an example graphical representation showing a relative interpretation of the cost/benefit of an LNAPL removal effort by calculating unit cost in dollars divided by the volume recovery rate in gallons or liters per year. The output is then normalized on a scale of 0-90 with 0 indicating the removal effort is excessively expensive relative to volume recovered and 90 representing the removal effort is extremely inexpensive relative to volume recovered.

### DETAILED DESCRIPTION

Inventors' Identification of Existing Needs for Present Invention

There are tens of thousands of sites across the world that have light non-aqueous phase liquid (LNAPL) contaminants present in conjunction with dissolved phase groundwater contamination. It has been recognized by the inventors that the dissolved phase of the contamination at the site typically arises from the same contaminants as may be found in the LNAPL being dissolved in the ground water. While there are numerous regulations regarding the acceptable/allowable amounts of dissolved phase groundwater contamination, there is very little clear and consistent regulatory guidance regarding the presence of LNAPL as far as the amount of LNAPL that is required to be removed. Some regulatory agencies require removal of LNAPL based on a prescribed thickness, while other agencies require removal of LNAPL until only a “sheen” remains or removal to the “maximum extent practicable”. There are also a number of institutions and committees working together to develop guidelines that address the point at which LNAPL should be recovered/removed from a site. These guidelines are based primarily on the practicability of LNAPL removal and best technologies to achieve such removal. However, the inventors are not aware that there has been any formulaic approach proffered that answers the question: “When does it become unnecessary to remove LNAPL, even when it is recoverable?” The inventor's premise is that even in the presence of recoverable LNAPL, if the dissolved phase groundwater plume is stable or shrinking and the LNAPL presents no unacceptable risks, there reaches a point when there is no relative benefit to remove recoverable LNAPL. In fact, removing recoverable LNAPL may actually produce a detriment in tetras of cost, increased health and safety risks, an increasing carbon footprint and/or other sustainability concerns. The inventors have invented, crafted and developed a method to evaluate when these detriments override the benefit of LNAPL removal. The method is called the “LNAPL Removal Benefit Analysis”.

In one aspect, embodiments disclosed herein relate to methods and systems for evaluating the benefit of removing LNAPL from a site with LNAPL and a related dissolved phase groundwater plume. It is again noted that throughout this disclosure it may be recognized that the dissolved phase contamination under consideration is typically the same chemicals as those of the LNAPL under consideration.

Typically, evaluations of LNAPL and/or the related dissolved phase groundwater remediation systems are performed to determine and evaluate the cost to maintain a system and/or to determine the amount of mass or the volume removed as a function of cost. Embodiments of the present disclosure provide methods to evaluate the benefit of removing LNAPL from a site as it relates to plume stability and various determined conditions. The Ricker Method® plume stability analysis involves the evaluation of a groundwater plume in terms of areal extent, average concentration, mass indicator, and location of the plume center of mass. A copy of an article Ricker Plume Stability Method™ (Ricker, 2008) is attached hereto as Appendix A and is incorporated by reference into this disclosure for all legitimate purposes. The Ricker Method® plume stability analysis is especially useful and practical, as it is not a “model”; but, rather, an empirical evaluation of specific data. The drawbacks of a model include the fact that output is heavily dependent on the proper use and selection of a potentially wide range of variable input data. Additionally, models by nature can be manipulated and interpreted differently by various modelers. Therefore, replication of modeled data becomes more complicated as the amount and variability of input data increases.

The Ricker Method® plume stability analysis provides an evaluation of fixed data sets with minimal data interpretation. Therefore the output generated via the Ricker Method® plume stability analysis using a fixed data set can be easily replicated on behalf of multiple users. The simplicity of the Ricker Method® plume stability analysis output also allows for confidence when evaluating the data. That is, for example, knowing that the output cannot be manipulated, a regulator can feel more comfortable with the results of a Ricker Plume Stability Method™ evaluation knowing that the output cannot be easily manipulated and can be readily replicated to provide the same results.

This simplicity and replication capability are reasons why the Ricker Method® plume stability analysis is gaining widespread acceptance in the environmental consulting and environmental regulatory arena. The Ricker Method® plume stability analysis has been accepted for use by US EPA Region W and is highlighted as a RCRA Showcase Pilot on the EPA website. Additionally, the Ricker Method® plume stability analysis was peer-reviewed and published in the Fall 2008 edition of the Ground Water Monitoring & Remediation journal published by the National Ground Water Association (NGWA). Also, states such as New Jersey, Indiana and Missouri are incorporating the Ricker Method plume stability analysis in their guidance for achieving risk-based closures at contaminated sites.

Using the outputs of the Ricker Method® plume stability analysis as a platform, the Applicant developed a proprietary remediation site evaluation tool called the Remediation System Benefit Analysis remediation site evaluation tool that has been promoted in the industry under Applicant's trademark for its RSBA® remediation site evaluation tool. The Applicant also submitted to the US Patent and Trademark Office a patent application directed to the RSBA® remediation site evaluation tool. That patent application titled “Method and System for Remediation System Benefit Analysis” filed Jun. 21, 2012 as U.S. patent application Ser. No. 13/529,462 that was published Jan. 3, 2013 as US Published Application No. 2013-0006538-A1 and is currently under patent review. (U.S. patent application Ser. No. 13/529,462 that was published Jan. 3, 2013 as US Published Application No. 2013-0006538-A1 is respectfully incorporated herein by reference for all legitimate purposes.) The RSBA® remediation site evaluation tool is applied to sites having active groundwater remediation systems (e.g. pump and treat) and where plume stability has been evaluated using the Ricker Method® plume stability analysis according to Appendix A hereto. The RSBA® site remediation evaluation tool provides an evaluation of the relative impact an active groundwater remediation system (e.g. pump and treat) is having on plume stability. In essence, the RSBA® remediation site evaluation tool analyzes the amount of contaminant mass that is being removed by a remediation system and the relative impact such removal is having on the stability of the plume. Additionally, RSBA® provides an evaluation of the costs to maintain such a system in context of efficiency/inefficiency (i.e. expensive or inexpensive). It should be noted that RSBA® remediation site evaluation tool was designed for evaluating remediation systems removing dissolved-phase contaminants and not for evaluating the removal of LNAPL contaminants. As explained herein, however, the LNAPL of consideration is typically constitutes the liquid phase of the dissolved-phase contaminants evaluated using the RSBA® site remediation evaluation tool.

LNAPL Removal Benefit Analysis

It should be noted that LNAPL Removal Benefit Analysis should only be considered when it has been determined that the presence of LNAPL creates no actual or presumed health exposure risks or when such risks can be adequately mitigated. Evaluation of health risk should be accomplished using acceptable industry standard procedures.

The LNAPL Removal Benefit Analysis is an interpretation of the relative benefit of removing LNAPL from a site with LNAPL and a related dissolved phase groundwater plume based on numeric and graphical data outputs from the measurement and evaluation of up to eight pertinent metrics. LNAPL Removal Benefit Analysis can be used to evaluate most LNAPL removal/recovery efforts.

The eight metrics that produce numeric and/or graphical outputs include:
The Ricker Method® plume stability analysis of assessing dissolved phase groundwater plume stability for the contaminants in question, namely, the dissolved phase of the contaminants also of possible concern in the liquid phase referred to as LNAPL;
Evaluation and/or prediction of asymptotic recovery curves/trends;
Relative cost trend;
Cost-Benefit Indicator;
Evaluation of sustainability;
LNAPL recoverability based on transmissivity;
Relative LNAPL center of mass movement vs. dissolve plume center of mass movement (optional); and
Rate of intrinsic LNAPL mass reduction (optional)

Accordingly to embodiments of the present disclosure, a score is assigned to each of the outputs as discussed further below. The scores for the first six metrics are totaled for a total LNAPL Removal Benefit Analysis score. Based on the total scoring a determination is made whether removal of LNAPL is necessary or unnecessary even in the presence of recoverable LNAPL. If the scoring falls into the “further evaluation” range, the outputs of the last two metrics above may be evaluated. The scores from these two metrics would then be added to the previously determined LNAPL Removal Benefit Analysis score to determine the final LNAPL Removal Benefit Analysis outcome.

Metrics

No. 1—Ricker Plume Stability Method™

The Ricker Method® plume stability analysis of evaluating groundwater plume stability (see Appendix A) should be conducted on the dissolved phase portion of a groundwater plume that is associated with the presence of LNAPL. For LNAPL Removal Benefit Analysis there are four possible outcomes of this analysis:
Dissolved phase groundwater plume is shrinking.
Dissolved phase groundwater plume is stable.
Dissolved phase groundwater plume is increasing.
Dissolved phase groundwater plume is indeterminate or has not been assessed using the Ricker Method®.

When it is determined the dissolved phase groundwater plume is shrinking, it is assigned a score of (+6).

When it is determined the dissolved phase groundwater plume is stable, it is assigned a score of (+4).

When it is determined the dissolved phase groundwater plume is increasing, it is assigned a score of (−6).

When it is determined the dissolved phase groundwater plume is indeterminate or if a Ricker Method® plume stability analysis has not been conducted, it is assigned a score of (−6).

No. 2—Evaluation and/or Prediction of Asymptotic Recovery Curves/Trends

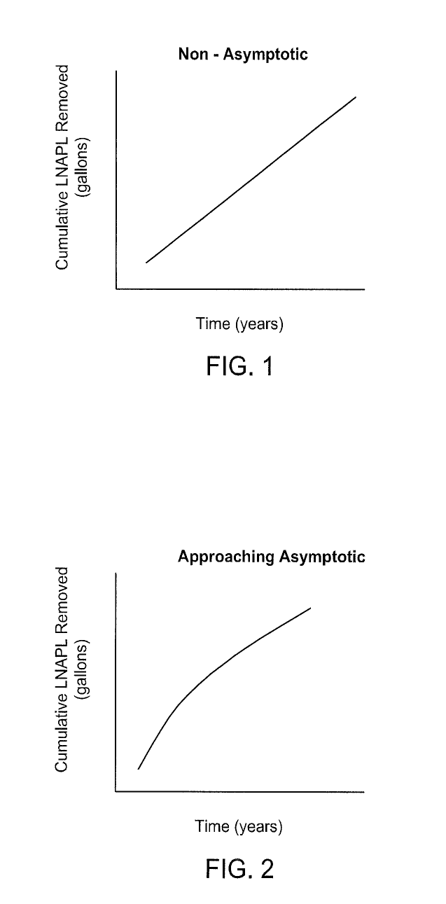

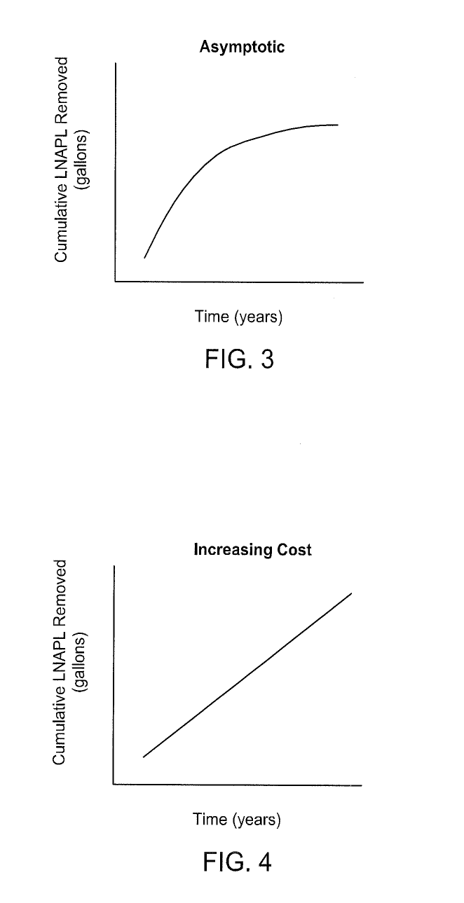

Based upon a set of numeric and graphical outputs, one can assess the relative benefit of removing LNAPL from a site by evaluating the LNAPL recovery rate of known volumes of recovered LNAPL. LNAPL recovery is typically recorded and graphed as volume (e.g. gallons, liters, etc.) removed (y-axis) over a period of time (x-axis). For LNAPL Removal Benefit Analysis, the cumulative amount of LNAPL recovered (y-axis) is plotted over a period of time (x-axis). The resulting curve is then evaluated as to its asymptotic condition (an asymptote is a straight line that continually approached by a curve but does not meet it within a finite distance). For LNAPL Removal Benefit Analysis there are three possible outcomes:
Non-asymptotic (i.e. linear), as shown in FIG. 1;
Approaching Asymptotic, as shown in FIG. 2; or
Asymptotic, as shown in FIG. 3.

A graphical example of each of these three conditions is provided below in FIGS. 1, 2 and 3.

FIG. 1 shows a resulting curve for LNAPL Removal Benefit Analysis, the cumulative amount of LNAPL recovered (y-axis) is plotted over a period of time (x-axis) that is determined to be “non-asymptotic”. When it is determined that the resulting curve is “non-asymptotic” it is assigned a score of (−2).

FIG. 2 shows a resulting curve for LNAPL Removal Benefit Analysis, the cumulative amount of LNAPL recovered (y-axis) is plotted over a period of time (x-axis) that is determined to be “approaching asymptotic”. When it is determined that the resulting curve is “approaching asymptotic” it is assigned a score of (0).

FIG. 3 shows a resulting curve for LNAPL Removal Benefit Analysis, the cumulative amount of LNAPL recovered (y-axis) is plotted over a period of time (x-axis) that is determined to be “asymptotic”. When it is determined that the resulting curve is “asymptotic” it is assigned a score of (+2).

There may be situations where the timeframe of collected LNAPL recovery is not sufficient (x-axis) to identify a definite curve to determine whether an asymptote is being approached. However, in this case the LNAPL Removal Benefit Analysis allows for the prediction of the asymptotic curve based on the application of accepted mathematical formulas. Based upon the mathematical prediction of the asymptotic curve, the following scores are assigned:

When it is predicted that the curve will continue to be “non-asymptotic” it is assigned a score of (−2).

When it is predicted that the curve will “approach asymptotic” within at least 5 to 10 years it is assigned a score of (0).

When it is predicted that the curve will reach “asymptotic” within at least 5 to 10 years it is assigned a score of (+1). The score is lower than the actual asymptotic condition of (+2) due to the predictive nature of the calculation. Once an actual asymptotic condition is reached based on actual data, the score can then be changed to (+2).

No. 3—Relative Cost Trend

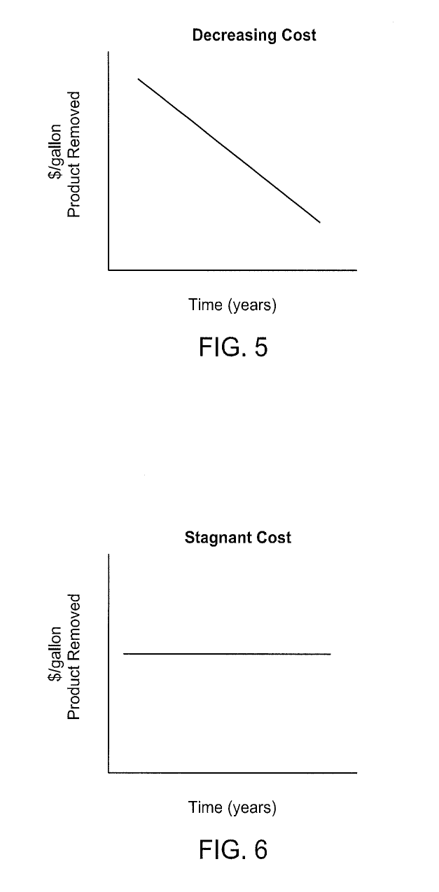

The Relative Cost Trend is an attempt to describe how much the LNAPL removal effort is costing relative to the amount of LNAPL volume being removed from the groundwater by the LNAPL removal effort. The Relative Cost Trend is determined by plotting the linear regression trend line of $ spent per volume unit (e.g. gallons, liters, etc.) of LNAPL removed over time. Depending on available input data, methods of plotting the ratio of $ spent per volume unit removed other than linear regression may be used (e.g. actual data plot, scatter plots, etc.). For LNAPL Removal Benefit Analysis there are three possible Relative Cost Trends that can be determined:
Increasing Cost, as shown graphically in FIG. 4;
Decreasing Cost, as shown graphically in FIG. 5; or
Stagnant (or Static) Cost, graphically in FIG. 4.

Graphical output examples for each of these three trends are provided in FIGS. 4, 5 and 6:

It should be noted that it is possible that the cost trend may consist of more than one trend over a given period of time. For example, when evaluating cost trends over a period of 25 years it is possible that during the first 10 years of operation of a system the cost trend was decreasing and then for a subsequent 15 year period the cost trend was increasing. More weight should be place on the most recent set of data to evaluate the current cost trend:

When it is determined that the cost trend is an “increasing cost”, see for example FIG. 4, it is assigned a score of (+2).

When it is determined that the cost trend is a “stagnant cost”, see for example FIG. 6, it is assigned a score of (0)

When it is determined that the cost trend is a “decreasing cost”, see for example FIG. 5, it is assigned a score of (−2).

No. 4—Cost/Benefit Indicator

Another LNAPL Removal Benefit Analysis graphical output is the Cost/Benefit Indicator. In essence, the Cost/Benefit Indicator provides a relative interpretation of the cost/benefit of an LNAPL removal effort by calculating unit cost in dollars divided by the volume recovery rate of LNAPL in gallons or liters per year. The output is then normalized on a scale of 0-90 with 0 indicating the removal effort is excessively expensive relative to volume recovered and 90 representing the removal effort is extremely inexpensive relative to volume recovered

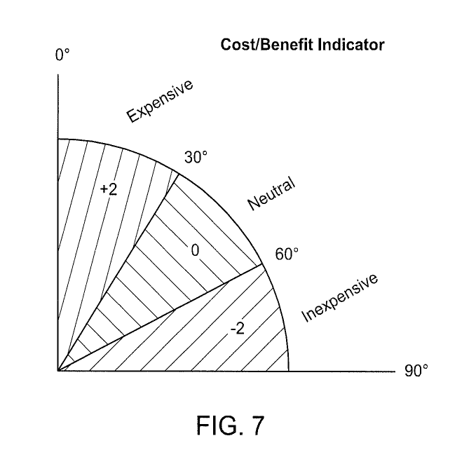

An example of the graphical output of the Cost/Benefit Indicator is provided below in FIG. 7.

With Reference to FIG. 7, when the Cost/Benefit Indicator outcome is between 0 and 30 it is assigned a score of (+2).

When the Cost/Benefit Indicator outcome is between 30 and 60 it is assigned a score of (0).

When the Cost/Benefit Indicator outcome is between 60 and 90 it is assigned a score of (−2).

No. 5—Evaluation of Sustainability

The relative sustainability of an active LNAPL removal effort will be based on the outcomes as determined by one or more tools for calculating the costs in terms of energy used, natural resource consumption, pollutant emissions, carbon footprint or other measures of environmental impact for various activities associated with remediation efforts. For example, such cost may be determined using a publically available computer software tool known as the “SiteWise™ Tool for Calculating Environmental Footprint of Remediation Alternatives”, jointly developed by the United States Navy, United States Corps of Engineers, and Battelle Memorial Institute, 505 King Avenue Columbus Ohio. As indicated herein, the SiteWise™ tool is implemented and conducted according the SiteWise™ Version 2 User Guide (June 2011) from Naval Facilities Engineering Command, Engineering Service Center, Port Hueneme, Calif. 93043-4370 (attached hereto as Appendix B and incorporated herein by reference for all legitimate purposes). According to another alternative example, the relative sustainability of an active LNAPL removal effort may be based upon calculating the costs for various activities associated with remediation efforts using the “Sustainable Remediation Tool” (SRT) developed by the Air Force Center for Engineering and the Environment (AFCEE) according to the presentation of the SRT by Charles J. Newell Ph.D., P.E. presented at the Global Perspectives in Green Remediation Symposium, Feb. 4, 2009 (attached hereto as Appendix C and incorporated by reference for all legitimate purposes.) As indicated herein, the “Sustainable Remediation Tool” (SRT) when discussed in this disclosure is implemented and conducted according the presentation materials attached hereto as Appendix C and incorporated herein by reference for all legitimate purposes. The relative sustainability of an active LNAPL removal effort may also be based on the outcomes as determined by one or more other tools as may be developed for calculating the costs in terms of money, carbon footprint or other measures of environmental impact for various activities associated with remediation efforts.

The SiteWise™ tool requires a variety of inputs that may be called for by the evaluation tool and to the extent such information may be available or obtainable for a given site, which can be summarized into four major categories: 1) production of material required by the activity, 2) transportation of the required materials, equipment, and personnel to and from the site, 3) all onsite activities to be performed, and 4) management of the waste produced by the activity. The outputs of the tool include GHG emissions (metric tons), total energy used (MMBTU), water consumption (gallons), NOx emissions (metric tons), SOx emissions (metric tons), PM10 emissions (metric tons), accident risk fatality, and accident rick injury. The Sustainable Remediation Tool (SRT) requires a description of the contaminated area with information such as type of containment, concentrations, plume dimensions, and soils and aquifer characteristics. The outputs of this tool are CO2 emissions (tons), energy used (mega joules), cost (dollars), safety/accident risk (lost hours), and resource service change.

There are three possible outcomes:
Active LNAPL removal effort is considered neutral;
Active LNAPL removal effort is considered sustainable; or
Active LNAPL removal effort is considered unsustainable.

When it is determined that the active LNAPL removal effort is sustainable it is assigned a score of (−2).

When it is determined that the active LNAPL removal effort is neutral it is assigned a score of (0).

When it is determined that the active LNAPL removal effort is unsustainable it is assigned a score of (+2).

No. 6—Evaluation of LNAPL Recoverability Based on Transmissivity

One method gaining recent industry traction to evaluate the relative recoverability of

LNAPL is measuring the LNAPL transmissivity, which is a measurement of the lateral mobility of LNAPL. API and ASTM have published LNAPL transmissivity guidance. Additionally, the ITRC Technical Guidance document of December 2009 suggests that transmissivity ranges between 0.1 and 0.8 ft²/day is an indication that the LNAPL is recoverable. As part of LNAPL Removal Benefit Analysis the transmissivity of LNAPL is to be measured.

When it is determined that the LNAPL Transmissivity is less than 0.1 ft²/day it is assigned a score of (+2).

When it is determined that the LNAPL Transmissivity is between 0.1 and 0.8 ft²/day it is assigned a score of (0).

When it is determined that the LNAPL Transmissivity is greater than 0.8 ft²/day it is assigned a score of (−2).

When the LNAPL Transmissivity cannot be technologically measured it is assigned a score of (−2).

LNAPL Removal Benefit Analysis Scoring

Once the metrics above are measured the total score for each metric is calculated. Based on the total score there are three possible outcomes:
Maintain LNAPL removal efforts (score of −6 to −16).

Further evaluation of necessity of LNAPL removal efforts (score of −6 to +6).
Cessation of LNAPL removal efforts (score of +6 to +16).

Optional Metrics

If the LNAPL Removal Benefit Analysis score is in the range of −6 to +6 the following optional evaluations can be run to evaluate the possibility of ceasing LNAPL removal efforts:

No. 7—Relative LNAPL Center of Mass Movement Vs. Dissolved Plume Center of Mass Movement (Optional)

To evaluate this metric the center of mass (COM) of the LNAPL plume, as determined by measured LNAPL thickness in a well, should be determined using the Ricker Method®. Similarly, the COM for the dissolved phase plume should also be determined using the Ricker Method®. Then the LNAPL COM movement over time will be compared to the dissolved phase COM movement over time. Movement is measured relative to a fixed benchmark and is determined to be moving upgradient, downgradient, sidegradient or not moving relative to groundwater flow direction. There are a number of possible outcomes:
The LNAPL COM is moving upgradient and the dissolved plume COM is moving upgradient or downgradient.
The LNAPL COM is moving downgradient and the dissolved plume COM is moving upgradient.
The LNAPL COM is moving downgradient and the dissolved plume COM is moving downgradient.
The LNAPL COM is not moving either downgradient or upgradient and the dissolved phase COM is moving upgradient or downgradient or not moving.

When it is determined that the LNAPL COM is moving upgradient and the dissolved plume COM is moving upgradient or downgradient it is assigned a score of (+2)

When it is determined that the LNAPL COM is moving downgradient and the dissolved plume COM is moving upgradient it is assigned a score of (−1). Additionally, if the LNAPL COM is moving toward a sensitive receptor within the boundary of the dissolved plume add another (−2) for a total score of (−3).

When it is determined that the LNAPL COM is moving downgradient and the dissolved plume COM is moving downgradient it is assigned a score of (−2). Additionally, if the LNAPL COM is moving toward a sensitive receptor within the boundary of the dissolved plume add another (−2) for a total score of (−4).

No. 8—Rate of LNAPL Mass Reduction (Optional)

CO₂ flux in the vadose zone can be indicative of source zone depletion via biodegradation. Carbon dioxide traps capturing CO₂ off gassing of the LNAPL body can be used to calculate the volume of LNAPL degraded to generate the CO₂ using conversion factor for CO₂ flux to LNAPL loss of 550 (gal/acre/year) per 1 (μmol/m2/sec) (McCoy 2012). The final result of this calculation can then be compared to the total amount removed by the remediation effort to assess whether the current or proposed removal effort or natural attenuation is relatively more effective in the degradation and removal of the LNAPL body.

In addition to the aforementioned CO₂ traps, there are other published methods of assessing in-place degradation of an LNAPL body. LNAPL Removal Benefit Analysis permits use of these other methods if they are peer-reviewed and industry accepted and the output is provided in a unit volume degradation rate which can be compared to an active LNAPL removal effort which typically measures LNAPL removed in gallons or liters.

There are three possible outcomes:
The amount of LNAPL degrading in place is greater than the amount of LNAPL removed by the LNAPL removal effort.
The amount of LNAPL degrading in place is equal to (within 10%) the amount of LNAPL removed by the LNAPL removal effort.
The amount of LNAPL degrading in place is less than the amount of LNAPL removed by the LNAPL removal effort.

When it is determined that the amount of LNAPL degrading in place is greater than the amount of LNAPL removed by the LNAPL removal effort it is assigned a score of (+2).

When it is determined that the amount of LNAPL degrading in place is equal to (within 10%) the amount of LNAPL removed by the LNAPL removal effort it is assigned a score of (0).

When it is determined that the amount of LNAPL degrading in place is less than the amount of LNAPL removed by the LNAPL removal effort it is assigned a score of (−2).

Once the score is ascertained by these two optional metrics, the Optional score is then added to the original LNAPL Removal Benefit Analysis score. If the optional score moves the total score into the +6 to +16 range, the LNAPL removal efforts should be considered for cessation and a natural source zone depletion approach should be evaluated for implementation.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. A method for evaluating the relative benefit of removing light non-aqueous phase liquid (LNAPL) contaminants from a site that has LNAPL and a dissolved phase groundwater plume, comprising:
a) evaluating dissolved plume stability using the Ricker Method® plume stability analysis to determine whether the condition of a groundwater plume is shrinking, stable, increasing, indeterminate or has not been assessed and assigning a predetermined numeric value based upon the condition of the ground plume stability,
b) evaluating LNAPL recovery rate by plotting a curve of recovered LNAPL against a period of time and determining for the resulting LNAPL recovery rate curve whether the asymptotic condition of the curve is non-asymptotic, approaching asymptotic, or asymptotic and assigning a numeric value based upon the asymptotic condition of the recovery rate curve,
c) evaluating a relative cost trend of the cost relative to the amount of LNAPL removal to determine whether the status of the cost trend is increasing, decreasing, or stagnant and assigning a numeric value based upon the status of the cost trend,
d) evaluating a relative cost-benefit indicator to characterize the amount of money spent per unit volume of LNAPL removed normalized on a scale of 0 to 90 (where 0 is most expensive and 90 is least expensive) and assigning a numeric value to the cost benefit indicator based upon whether normalized cost benefit was in a determined range of 0-30, 30-60, or 60-90,
e) evaluating relative sustainability as determined on the basis of production material required, transportation of material, equipment and personnel to the remediation site, all on site activities to be performed in the remediation, and management of waste production to determine based upon the CO2 emissions (tons), energy used (megajoules), cost (dollars), safety/accident risk (lost hours), and resource service change whether the character of the relative sustainability of the activity of removing LNAPL is sustainable, neutral or unsustainable and to assigning a numeric value based upon the character of the relative sustainability;
f) evaluating the LNAPL transmissivity to determine whether the transmissivity of the LNAPL is within a range of less than 0.1 ft²/day, between 0.1 and 0.8 ft²/day, greater than 0.8 ft²/day or cannot be technologically measured and assigning a numeric value based upon the range of transmissivity; and
g) calculating the sum of the numeric values assigned for all the evaluating and determining based upon the sum whether to consider or maintain LNAPL removal efforts, to further evaluate the necessity of LNAPL removal efforts, or to not consider or discontinue LNAPL removal efforts.

2. The method for evaluating the relative benefit of removing LNAPL from a site with LNAPL and a dissolved phase groundwater plume of claim 1, wherein the evaluating of relative sustainability includes determining relative sustainability using the “SiteWise™ Tool for Calculating Environmental Footprint of Remediation Alternatives”.

3. The method for evaluating the relative benefit of removing LNAPL from a site with LNAPL and a dissolved phase groundwater plume of claim 1, wherein the evaluating of relative sustainability includes determining relative sustainability using the “Sustainable Remediation Tool (SRT) developed by the Air Force Center for Engineering and the Environment (AFCEE).”

4. The method for evaluating the relative benefit of removing LNAPL from a site with LNAPL and a dissolved phase groundwater plume of claim 1, wherein:
a) assigning a predetermined numeric value based upon the condition of the ground plume stability comprises assigning a value of +6 when the condition of a groundwater plume is shrinking, assigning a value of +4 when the condition of a groundwater plume is stable, assigning a value of −6 when the condition of a groundwater plume is increasing, assigning a value of −6 when the condition of a groundwater plume is indeterminate or has not been assessed and,
b) assigning a numeric value based upon the asymptotic condition of the recovery rate curve comprises assigning a value of −2 when the asymptotic condition of the curve is non-asymptotic, assigning a value of 0 when the asymptotic condition of the curve is approaching asymptotic, or assigning a value of +2 when the asymptotic condition of the curve is asymptotic,
c) assigning a numeric value based upon the status of the cost trend comprises assigning the value of +2 when the status of the cost trend is increasing, assigning the value of −2 when the status of the cost trend is decreasing, and assigning the value of 0 when the status of the cost trend is stagnant,
d) assigning a numeric value to the cost benefit indicator comprises assigning the value of +2 when the normalized cost benefit is in the range of 0-30, assigning the value of 0 when the normalized cost benefit is in the range of 30-60, and assigning the value of −2 when the normalized cost benefit is in the range of 60-90,
e) assigning a numeric value based upon the character of the relative sustainability comprises assigning a value of −2 when the character of the relative sustainability of LNAPL removal efforts is sustainable, assigning a value of 0 when the character of the relative sustainability of LNAPL removal efforts is neutral and assigning a value of +2 when the character of the relative sustainability of LNAPL removal efforts is unsustainable and to assigning a numeric value based upon the character of the relative sustainability; and
f) determining to consider implementing or maintaining LNAPL removal efforts when the sum of all of the evaluations is a score of −6 to −16, further determining the necessity of LNAPL removal efforts when the sum of all of the evaluations is a score of −6 to +6, and determining to not consider or discontinue the LNAPL removal efforts when the sum of all of the evaluations is a score of +6 to +16.

5. The method for evaluating the relative benefit of removing LNAPL of claim 1, wherein the LNAPL Removal Benefit Analysis score is determined in the range of −6 to +6, further comprising:
a) evaluating a relative LNAPL center of mass (LNAPL COM) movement over time to determine whether the LNAPL COM movement is upgradient, downgradient, side gradient or not moving relative to a fixed benchmark;
b) evaluating the dissolved phase plume center of mass (dissolved plume COM) movement over time to determine whether the plume COM movement is upgradient, downgradient, side gradient or not moving relative to the fixed benchmark;
c) comparing the LNAPL COM movement to the plume COM movement to determine whether the relative movement is the LNAPL COM is moving upgradient and the dissolved plume COM is moving upgradient or downgradient, the LNAPL COM is moving downgradient and the dissolved plume COM is moving upgradient, the LNAPL COM is moving downgradient and the dissolved plume COM is moving downgradient, or LNAPL COM is not moving downgradient or upgradient and the dissolved plume COM is moving downgradient, upgradient or not moving and assigning a predetermined numeric value to each of the different comparative relative movements;
d) assessing in-place degradation of an LNAPL body to determine whether the amount of LNAPL degrading in place is greater than the amount of LNAPL removed by the LNAPL removal efforts, the amount of LNAPL degrading in place is equal to (within 10%) the amount of LNAPL removed by the LNAPL removal efforts, or the amount of LNAPL degrading in place is equal to (within 10%) the amount of LNAPL removed by the LNAPL removal efforts and assigning a predetermined numeric value to the determined in-place degradation of the LNAPL body.

6. The method for evaluating the relative benefit of removing LNAPL of claim 5, wherein assigning a numeric value to each of the different comparative relative movements and to the in-place degradation of an LNAPL body comprises:
a) assigning a score of (+2) when it is determined that the LNAPL COM is moving upgradient and the dissolved plume COM is moving upgradient or downgradient;
b) assigning a score of (−1) when it is determined that the LNAPL COM is moving downgradient and the dissolved plume COM is moving upgradient. Additionally, if the LNAPL COM is moving toward a sensitive receptor within the boundary of the dissolved plume add another (−2) for a total score of (−3);
c) assigning a score of (−2) when it is determined that the LNAPL COM is moving downgradient and the dissolved plume COM is moving downgradient. Additionally, if the LNAPL COM is moving toward a sensitive receptor within the boundary of the dissolved plume add another (−2) for a total score of (−4).
d) assigning a score of (+2) when the amount of LNAPL degrading in place is greater than the amount of LNAPL removed by the LNAPL removal efforts;
e) assigning a score of (0) when the amount of LNAPL degrading in place is equal to (within 10%) the amount of LNAPL removed by the LNAPL removal efforts;
f) assigning a score of (−2) when the amount of LNAPL degrading in place is less than the amount of LNAPL removed by the LNAPL removal efforts; and
g) adding to the assigned a numeric values of the comparative relative movements and of the in-place degradation of an LNAPL body to the LNAPL Removal Benefit Analysis score of −6 to +6 and if the optional score moves the total score into the +6 to +16 range, considering ceasing LNAPL removal efforts and for a natural source zone depletion approach for implementation.

7. A method for evaluating the relative benefit of removing light non-aqueous phase liquid (LNAPL) contaminants from a site that has LNAPL and a dissolved phase groundwater plume, comprising:
a) evaluating dissolved plume stability by determining whether the condition of a groundwater plume is shrinking, stable, increasing, indeterminate or has not been assessed and assigning a predetermined numeric value based upon the condition of the ground plume stability,
b) evaluating LNAPL recovery rate by plotting a curve of recovered LNAPL against a period of time and determining for the resulting LNAPL recovery rate curve whether the asymptotic condition of the curve is non-asymptotic, approaching asymptotic, or asymptotic and assigning a numeric value based upon the asymptotic condition of the recovery rate curve,
c) evaluating a relative cost trend of the cost relative to the amount of LNAPL removal to determine whether the status of the cost trend is increasing, decreasing, or stagnant and assigning a numeric value based upon the status of the cost trend,
d) evaluating a relative cost-benefit indicator to characterize the amount of money spent per unit volume of LNAPL removed normalized on a scale of 0 to 90 (where 0 is most expensive and 90 is least expensive) and assigning a numeric value to the cost benefit indicator based upon whether normalized cost benefit was in a determined range of 0-30, 30-60, or 60-90,
e) evaluating relative sustainability as determined on the basis of production material required, transportation of material, equipment and personnel to the remediation site, all on site activities to be performed in the remediation, and management of waste production to determine based upon the CO2 emissions (tons), energy used (megajoules), cost (dollars), safety/accident risk (lost hours), and resource service change whether the character of the relative sustainability of the activity of removing LNAPL is sustainable, neutral or unsustainable and to assigning a numeric value based upon the character of the relative sustainability;
f) evaluating the LNAPL transmissivity to determine whether the transmissivity of the LNAPL is within a range of less than 0.1 ft²/day, between 0.1 and 0.8 ft²/day, greater than 0.8 ft²/day or cannot be technologically measured and assigning a numeric value based upon the range of transmissivity; and
g) calculating the sum of the numeric values assigned for all the evaluating and determining based upon the sum whether to consider or maintain LNAPL removal efforts, to further evaluate the necessity of LNAPL removal efforts, or to not consider or discontinue LNAPL removal efforts.
